(19) United States
(12) Patent Application Publication
(10) Pub. No.: US 2026/0064121 A1
(43) Pub. Date: Mar. 5, 2026

(54) UNMANNED AERIAL VEHICLE OPERATION AND MISSION PLANNING IN LOW LIGHT ENVIRONMENT

(71) Applicant: Wing Aviation LLC, Palo Alto, CA (US)

(72) Inventors: Domitille Commun, Washington, DC (US); Ali Shoeb, San Rafael, CA (US); Martín Gomez, Redwood City, CA (US)

(21) Appl. No.: 18/820,733

(22) Filed: Aug. 30, 2024

(51) Int. Cl. G05D 1/246; G05D 1/646; G05D 1/667; G05D 109/20; G06T 7/73; G06T 15/50; G06T 17/05; G06V 10/26; G06V 10/60; G06V 20/17

(52) U.S. Cl. CPC G05D 1/2462; G05D 1/646; G05D 1/667; G06T 7/73; G06T 15/506; G06T 17/05; G06V 10/26; G06V 10/60; G06V 20/17; G05D 2109/20; G06T 2207/10032

(57) ABSTRACT

A method for unmanned aerial vehicle (UAV) mission planning includes acquiring a target aerial image of a geographic area representative of the geographic area illuminated by one or more artificial light sources, identifying a location of the one or more artificial light sources based on the target aerial image, rendering a simulated aerial image representative of the geographic area illuminated by the one or more artificial light sources at night using a digital surface model of the geographic area, the location of the one or more artificial light sources, and an irradiance parameter for the one or more artificial light sources, identifying one or more regions within the geographic area as having sufficient lighting for UAV operation at night based on the simulated aerial image, and generating a mission plan for the UAV based on the one or more regions within the geographic area.

### TECHNICAL FIELD

This disclosure relates generally to mission planning for unmanned aerial vehicles (UAVs), and in particular but not exclusively, relates to UAV mission planning and operation within a low light (e.g., night) environment.

### BACKGROUND INFORMATION

An unmanned vehicle, which may also be referred to as an autonomous vehicle, is a vehicle capable of traveling without a physically present human operator. Various types of unmanned vehicles exist for various different environments. For instance, unmanned vehicles exist for operation in the air, on the ground, underwater, and in space. Unmanned vehicles also exist for hybrid operations in which multi-environment operation is possible. Unmanned vehicles may be provisioned to perform various different missions, including payload delivery, exploration/reconnaissance, imaging, public safety, surveillance, or otherwise. The mission definition will often dictate a type of specialized equipment and/or configuration of the unmanned vehicle.

Unmanned aerial vehicles (also referred to as drones) can be adapted for package delivery missions to provide an aerial delivery service. One type of unmanned aerial vehicle (UAV) is a vertical takeoff and landing (VTOL) UAV. VTOL UAVs are particularly well-suited for package delivery missions. The VTOL capability enables a UAV to takeoff and land within a small footprint thereby providing package pick-ups and deliveries almost anywhere. To safely deliver packages in a variety of environments, the UAV should be capable, inter alia, of viewing the ground where packages are to be dropped off to ensure the delivery site is clear of obstructions or otherwise maintain safe operating conditions. However, low light environments (e.g., night, dawn, dusk) may limit where the UAV may safely operate.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 illustrates operation of a UAV delivery service that delivers packages into a neighborhood, in accordance with an embodiment of the disclosure.

FIG. 2A illustrates a schematic for determining whether areas within a geographic area are sufficiently illuminated in low light environments by one or more artificial light sources, in accordance with an embodiment of the disclosure.

FIG. 2B illustrates example simulated images rendered for UAV mission planning for light low light operation, in accordance with an embodiment of the disclosure.

FIG. 3A illustrates an example process for determining a location of one or more artificial light sources within a geographic area, in accordance with an embodiment of the disclosure.

FIG. 3B illustrates an example process for extracting scene parameters from an aerial image and rendering a simulated aerial image, in accordance with an embodiment of the disclosure.

FIG. 4A and FIG. 4B are example flow charts illustrating processes for generation of a night terrain model and application of the night terrain model for UAV mission planning and operation, in accordance with embodiments of the disclosure.

FIG. 5 illustrates a UAV verifying delivery site viability included in geographic area using a night terrain model, in accordance with an embodiment of the disclosure.

FIG. 6A is a perspective view illustration of a UAV configured for use in a UAV delivery system, in accordance with an embodiment of the disclosure.

FIG. 6B is an underside plan view illustration of the UAV configured for use in the UAV delivery system, in accordance with an embodiment of the disclosure.

### DETAILED DESCRIPTION

Embodiments of a system, apparatus, and method of low light operation or mission planning for an unmanned aerial vehicle (UAV) are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

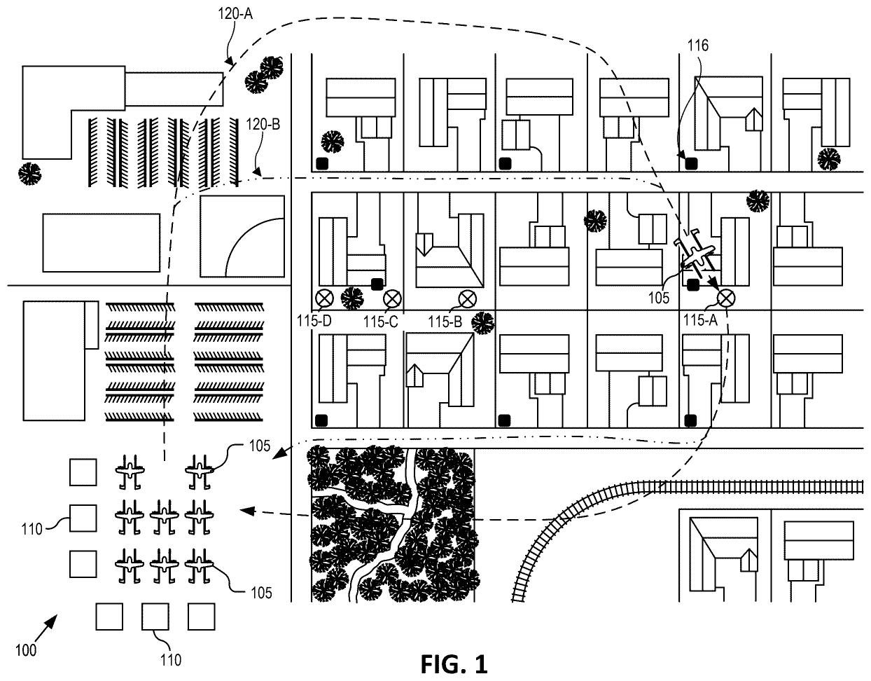

FIG. 1 illustrates operation of a UAV delivery service that delivers packages into a neighborhood, in accordance with an embodiment of the disclosure. UAVs may one day routinely deliver items into urban or suburban neighborhoods from small regional or neighborhood hubs such as terminal area 100 (also referred to as a local nest or staging area). Vendor facilities that wish to take advantage of the aerial delivery service may set up adjacent to terminal area 100 (such as vendor facilities 110) or be dispersed throughout the neighborhood for waypoint package pickups (not illustrated). An example aerial delivery mission may include a UAV 105 taking off from terminal area 100 with a package for delivery to a destination area 115-A (also referred to as a delivery zone, delivery site, or drop zone within a geographic area), rising to a cruising altitude, and cruising to the customer destination. At destination area 115-A, UAV 105 descends for package drop-off before once again ascending to a cruise altitude for the return journey back to terminal area 100.

During a given delivery mission, a UAV (e.g., UAV 105) may rely on global navigation satellite systems (GNSS) data for a majority of the delivery mission (e.g., to determine a UAV position and speed) when traveling between a UAV nest or depot (e.g., terminal area 100) and a delivery zone (e.g. destination area 115-A). However, when attempting to drop off a package to a specific location within the delivery zone, more granular details of the environment associated with the delivery zone may be desired to ensure delivery accuracy and safety. For example, images captured by the UAV during operation may play a more central role during descent and package drop off portions of a delivery mission. In other words, UAVs may rely on computer vision techniques (e.g., visual inertial odometry) in lieu of or in combination with sensor data (e.g., GNSS sensor, IMU, capture aerial images representative of a view of the ground below the UAV, and the like) to determine local position and orientation of the UAV, determine availability of a delivery zone, identify objects around and below the UAV, facilitate decision making (e.g., obstacle avoidance or abort), or otherwise provide a redundancy to GNSS data when attempting to deliver a package to a delivery zone. For example, GNSS positioning may fail for a number of reasons or otherwise have insufficient accuracy by itself and thus reliance on the perception system of the UAV increases. UAVs may therefore employ a number of methods or techniques using a perception system including one or more onboard cameras of the UAV to serve as a backup or replacement to GNSS data. In another example, the perception system may provide higher accuracy for estimating UAV above ground level (AGL) relative to GNSS data during the descend and hold stage of a delivery mission. Descending to a particular height and holding position is particularly important as once over the delivery zone, the UAV may winch the package down for placement at the delivery zone. It is therefore desirable to accurately maintain UAV position while also ensuring that the delivery zone is clear (e.g., not obstructed by an object, a person, an animal, or the like) before and during the descend and hold stage of the delivery mission.

However, insufficient lighting may limit functionality of the UAV perception system. In particular, passive components of the UAV perception system (e.g., one or more onboard image sensors and corresponding modules reliant on images output by the one or more onboard image sensors) may have limited operability in low light environments. Consequently, package delivery during low light conditions (e.g., night, dusk, dawn, or other low light environments) by UAVs may be challenging since one or more components of the perception system that a UAV uses for navigation, scene identification, package delivery, decision making, or the like may be unavailable if there is insufficient light. Put in another way, safe and effective parcel delivery via UAV during low light conditions is possible when there is sufficient artificial light (e.g., from streetlamps, porch lights, light fixtures, or other fixed artificial light sources) available within a given delivery zone, or more generally, a geographic area the UAV is operating within.

It is appreciated that illumination is complex in the real world and simply knowing that an artificial light source is available is not necessarily sufficient to determine whether night delivery for a delivery zone is viable. Light interacts with the environment and how much light is received by an object (i.e., so the object can be observed by the UAV) depends on environmental conditions such as scene geometry. For example, a geographic area may have one or more delivery zones or sites available for package placement, but depending on the scene geometry, light from a nearby artificial light source may be obstructed from illuminating the one or more specific delivery sites (e.g., a shadow cast on a specific site within a delivery zone may inhibit the UAV from determining whether the delivery zone is clear or otherwise safe for package placement). Thus, UAV delivery operations may be improved and/or expanded by modeling the brightness of a delivery zone at night illuminated by one or more artificial light sources while taking into consideration local geometry and occlusion within the environment.

To facilitate low light operation of UAVs, embodiments of the disclosure consider artificial light source location while taking into consideration local geometry and occlusion with the environment when generating a mission plan and/or providing instructions to perform action(s) for UAVs. For example, a digital surface model representative of the geographic area illustrated by FIG. 1 in combination with locations of artificial light sources 116 (e.g., streetlamps, light poles, porch lights, light fixtures, or other fixed artificial light sources), and irradiance parameter estimates for artificial light sources 116 can be used as scene parameters input into a renderer to generate 2D or 3D images (e.g., simulated aerial images) that are representative of the geographic area illuminated by the artificial light sources 116. Advantageously, the simulated aerial images, or other 2D/3D images generated by the renderer, may then be used to determine which areas within the geographic area are sufficiently illuminated. Put in another way, the renderer may be used to generate simulated aerial images that are representative of what an onboard camera system of the UAV is expected to see during a low light delivery mission, which can be used to aid in mission planning and operation.

Knowing which areas within a geographic area are expected to be illuminated by artificial light sources 116 enables low light operation of UAV 105 and/or mission planning for UAV 105. For example, a simulated aerial image of delivery zone 115-A may be used to determine whether delivery zone 115-A is sufficiently illuminated for package delivery (e.g., such that delivery zone 115-A can be observed by the UAV with sufficient detail to determine whether delivery zone 115-A is obstructed by a person, animal, or object). It is appreciated that the perception system of UAV 105 may include various modules (e.g., an obstacle avoidance/abort module to identify and avoid objects or abort the delivery mission, a scene detection module to identify elements of a given scene, a visual inertial odometry module to determine a pose, height, or above ground level of the UAV, other UAV modules that facilitate operation of the UAV within the onboard camera system of the system, or combinations thereof) that rely on aerial images captured by the onboard camera system of UAV 105. However, the operation of these modules included in the perception system of UAV 105 may have different requirements under low light conditions. Thus, during mission planning, a simulated aerial image of delivery zone 105-A may be utilized to determine whether one or more of the modules within the perception system of UAV 105 are expected to be operable, which aids in determining whether delivery zone 115-A is viable for low light operation.

In one embodiment, viability of other delivery zones within the geographic area represented by FIG. 1 may be determined (e.g., based on whether the other delivery zones are sufficiently illuminated by the artificial light sources 116). For example, one or more simulated 2D or 3D aerial images of the geographic area illuminated by the artificial light sources 116 may be generated to determine that delivery zone 115-C is viable for low light operation while delivery zones 115-B and 115-D are not viable for low light operation (e.g., illumination provided by the nearby artificial light is obstructed by a fence and a tree, respectively).

In another embodiment, a flight path of UAV 105 may be altered to preferentially fly over illuminated areas that are sufficiently illuminated (e.g., such that one or more of artificial light sources 116 are within a field of view of an onboard camera of UAV 105 and/or within a predetermined distance from UAV 105) to maintain availability of one or more modules within the perception system of UAV 105 during a given mission plan. In some embodiments, a flight path of UAV 105 may be altered to preferentially fly over sufficiently illuminated areas. For example, UAV 105 may be instructed to traverse flight path 120-A to drop off a package to delivery zone 115-A during bright conditions (e.g., daytime) that avoids flying directly over houses, but during low light conditions (e.g., night, dusk, dawn) UAV 105, flight path 120-A may be altered to correspond to flight path 120-B such that UAV 105 preferentially keeps artificial light sources 116 within a field of view of an onboard camera system of UAV 105 (e.g., such that one or more modules of the perception system of UAV 105 are available to ensure safe and effective delivery). It is appreciated that in some embodiments the altered flight path of UAV 105 for low light conditions may not necessarily be the fastest or most direct path to deliver a package (e.g., an indirect path may be generated to maintain availability of the one or more modules of the perception system of UAV 105).

In one embodiment, aerial images captured during a delivery mission of UAV 105 may be utilized (e.g., in real time for instructing UAV 105 to perform actions or offline for mission planning) in combination with simulated 2D or 3D aerial images to validate, or provide a backup to, sensor data from UAV 105 (e.g., GNSS data indicating location, pose information from IMU data, above ground level estimate from an altimeter, or the like). It is appreciated that the simulated aerial images may be generated by UAV 105 or by a backend management system (not illustrated). In some embodiments, the aerial images captured by UAV 105 may be used to estimate at least one of an above ground level (AGL), position, or orientation of UAV 105. In one example, an observed brightness of one or more of artificial light sources 116 provided by an aerial image captured by UAV 105 may be compared to an expected brightness of a simulated aerial image when captured at a given AGL to estimate an AGL of the UAV. In another embodiment, a constellation of one or more of artificial light sources 116 included in an aerial image captured by UAV 105 may be identified and referenced to a simulated aerial image that includes the constellation of lights to estimate a position and/or pose of UAV 105.

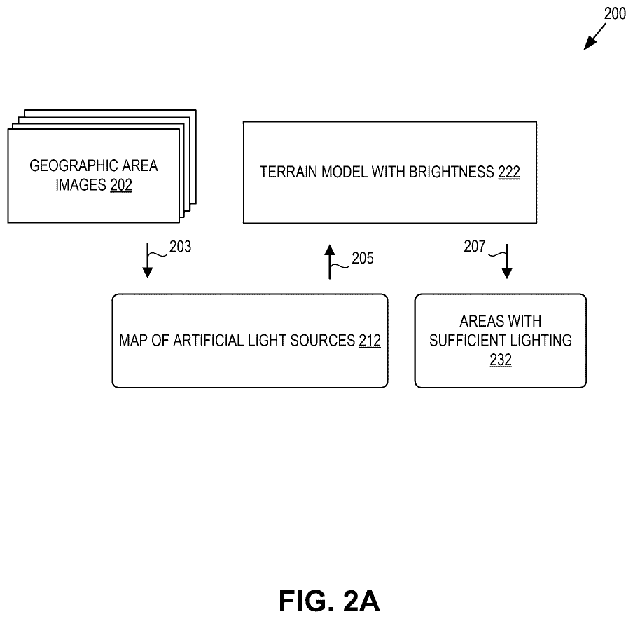

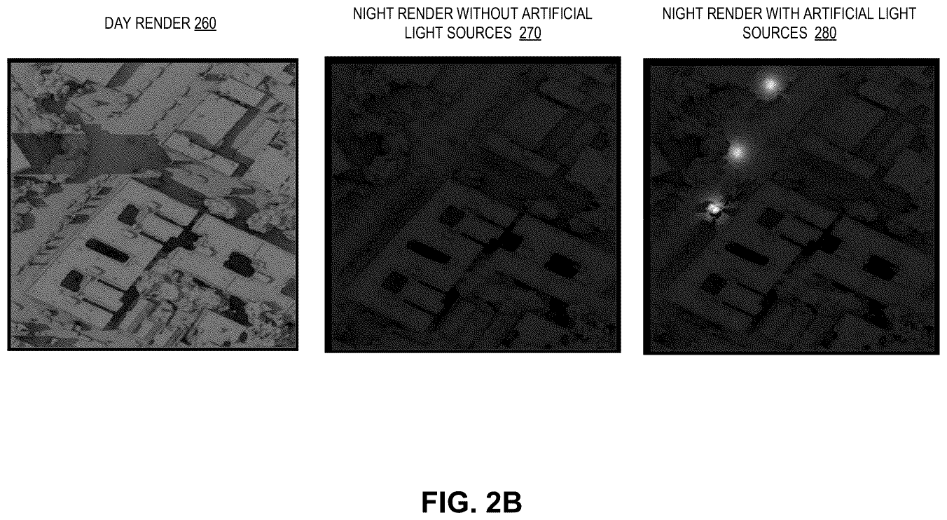

FIG. 2A illustrates a schematic 200 for determining whether areas within a geographic area are sufficiently illuminated in low light environments by one or more artificial light sources, in accordance with an embodiment of the disclosure. More specifically, schematic 200 provides a generalized example for generating a night terrain model of a geographic area that takes into account illumination provided by artificial light sources while still considering local geometry and occlusion within the environment.

Schematic 200 illustrates acquiring geographic area images 202 (e.g., images of a geographic area). In some embodiments, geographic area images 202 include aerial images of the geographic area that are illuminated by one or more artificial light sources (e.g., images captured at night by a UAV, manned aerial vehicle, or satellite). In the same or other embodiments, geographic area images 202 include aerial images of the geographic area showing one or more artificial light sources (e.g., during daytime). In the same or other embodiments, geographic area images 202 include street view images of the geographic area (e.g., non-aerial images) showing one or more artificial light sources. More generally, geographic area images 202 may include two classes of images, a first class of images that are aerial images representative of the geographic area illuminated by one or more artificial light sources and a second class of images that may be aerial or non-aerial images that are representative of views of the geographic area with one or more artificial light sources. It is appreciated that both the first and second classes of images included in the geographic area images 202 may be utilized to generate a map of artificial light sources 212 (e.g., a location such as latitude, longitude and/or position such as height) while the first class of images may also be used to estimate irradiance parameters of one or more artificial light sources as the first class of images are aerial images representative of the geographic area illuminated by one or more artificial light sources (e.g., images captured in low light conditions while the one or more artificial light sources are emitting light).

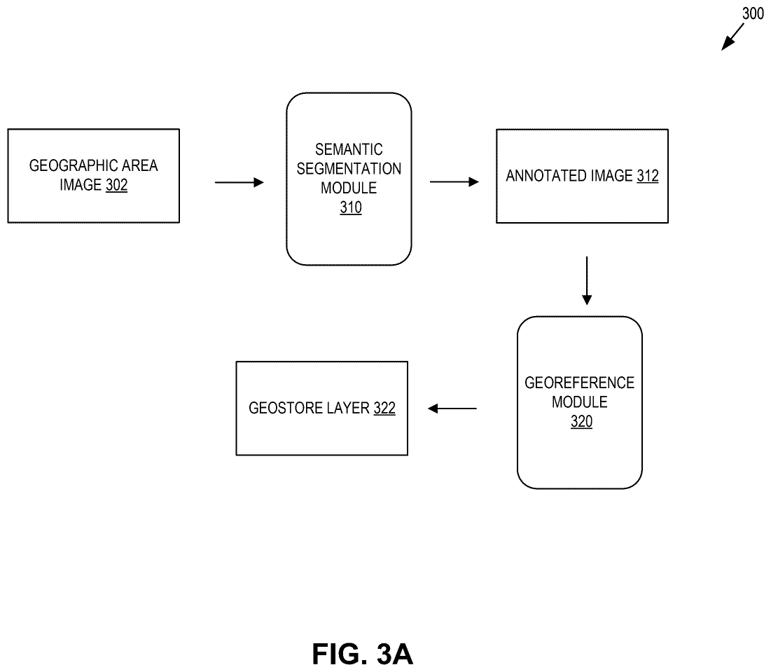

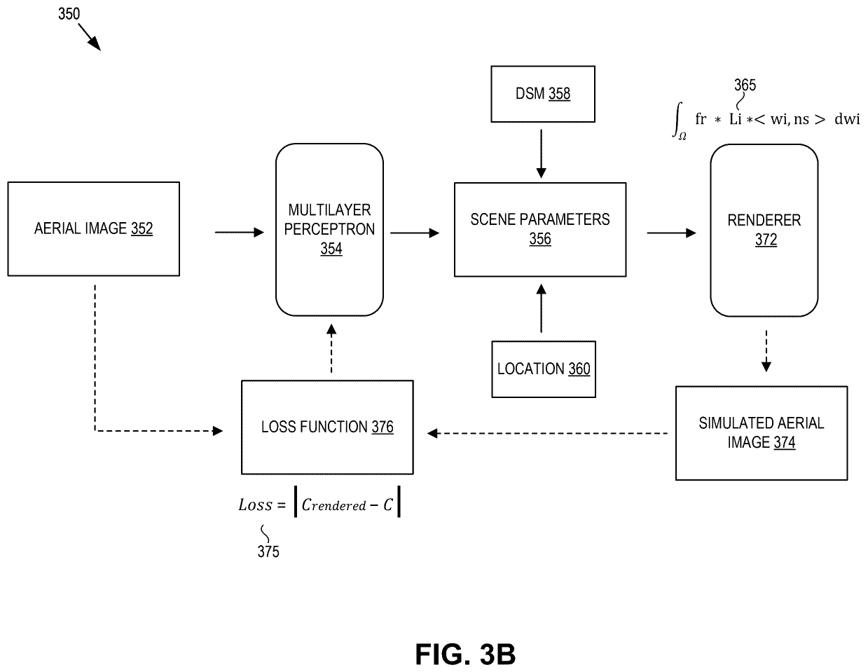

Map of artificial light sources 212 (e.g., a geostore layer) indicates coordinates and/or height of individual artificial light sources within a geographic area and may be determined by process 203 (see, e.g., FIG. 3A-3B), Geographic area images 202 may be subsequently analyzed by process 203 to determine a position (e.g., pixel coordinates) corresponding to artificial light sources. In one embodiment, semantic segmentation or other machine learning techniques (e.g., inference) may be utilized or otherwise applied to label objects within the geographic area images 202. Pixels of geographic area images 202 that are labeled as being associated with artificial light sources (e.g., streetlamps, porch lights, light fixtures, or other fixed artificial light source corresponding to one or more artificial light sources) may then be identified to determine the position of the one or more artificial light sources within the geographic area images 202. In the same or another embodiment, the position of the one or more artificial light sources may be determined using a night aerial image representative of the geographic area. Portions of the night aerial image that have a high intensity or brightness may be identified as a position of an artificial light source.

The position of the one or more artificial light sources within the geographic area images 202 may then be mapped to corresponding coordinates within a terrain model (e.g., digital surface model, point cloud, meshes, or other three-dimensional representation) of the geographic area to determine a location of the one or more artificial light sources. In some embodiments, the terrain model may include a geostore layer indicating a location of features or objects within the geographic area. Accordingly, in some embodiments, the geostore layer may be generated or updated to include the locations of the one or more artificial light sources. It is appreciated that there are many ways in which the position of the artificial light sources within the geographic area images 202 may be mapped to coordinates within the terrain model. In one embodiment, a spatial reference system is used to translate pixel coordinates to coordinates within the terrain model (e.g., georeferencing). For example, metadata associated with the geographic area images 202 (e.g., latitude, longitude, height, and/or AGL when the image was captured) may be used to determine a latitude and longitude of the one or more artificial light sources. For example, an aerial image included in the geographic area images 202 may have a center pixel annotated as having a coordinate corresponding to the latitude and longitude of a UAV utilized to capture the aerial image. Then based on other metadata associated with the aerial image (e.g., height or AGL when captured, focal length, or the like), the latitude and longitude of the one or more artificial light sources may be determined. Subsequently, the latitude and longitude of the one or more artificial light sources may then be translated to the coordinate system of the terrain model to indicate the location of the one or more artificial light sources within the terrain model.

In another embodiment, the terrain model may be utilized to generate or render a simulated image of the geographic area. The simulated image may be compared with the geographic area images 202 to generate a transformation matrix (e.g., using feature detection and matching) that matches the pixels of the geographic area images 202 to pixels of the simulated image of the geographic area. The transformation matrix may then be used to map the identified pixels of geographic area images 202 (e.g., pixels representing one or more artificial light sources) to corresponding pixels of the simulated image which can subsequently be mapped to specific coordinates within the terrain model of the geographic area since the terrain model was used to render the simulated image. In the same or another embodiment, inverse rendering may be utilized to recover scene information from the geographic area images 202 (see, e.g., FIG. 3B). Specifically, a multilayer perceptron (e.g., a deep neural network) may be trained to output a location of an artificial light source in response to an input image (e.g., geographic area images 202). In some embodiments, inference (e.g., segmentation and georeferencing) may be utilized to determine a first estimate of the location for one or more of the artificial light sources. Subsequently, inverse rendering may be utilized to generate a second estimate for the location that revises the first estimate.

Terrain model with brightness 222 (e.g., a night terrain model) of the geographic area can then be generated once a location, or at least an estimate of the location, for the one or more artificial light sources within the geographic area is determined by process 205 (see, e.g., FIG. 3B). It is appreciated that in some embodiments, a renderer that takes a terrain model (e.g., a digital surface model), map of artificial light sources 212, and corresponding irradiance parameter estimates for map of artificial light sources 212 may collectively correspond to terrain model with brightness 222 that can render 2D or 3D images representative of the geographic area at night illuminated by artificial light sources that takes into account scene geometry and occlusions. In some embodiments, the terrain model corresponds to a digital surface model representative of the geographic area. In some embodiments, the digital surface model may correspond to an aerial image of the geographic area having pixel colors indicative of a height or depth. In the same or other embodiments, each pixel of the digital surface model is annotated to indicate height or depth. The renderer may subsequently used the digital surface model, or more specifically the pixel colors or annotations, to generate a depth map, which in combination with the map or location of the one or more artificial light sources and the corresponding irradiance parameter estimates for the one or more artificial light sources can be used by the renderer a simulated 2D or 3D aerial image representative of the geographic area at night illuminated by the one or more artificial light sources.

As discussed previously, illumination is complex and simply knowing that an artificial light source is available is not necessarily sufficient to determine whether night delivery for a delivery zone is viable. In other words, it is desirable for the night terrain model to indicate irradiance of the one or more artificial light sources from a UAV perspective (e.g., aerial image). In one embodiment, a machine-learning based approach using differential rendering to model illumination for a geographic area is used. It is appreciated that differentiable rendering can be used to solve inverse problems involving light. Specifically, a differentiable renderer interprets a rendering algorithm as a function that converts an input (e.g., a scene description) into an output (e.g., a rendering of the scene based on the input). In one embodiment, the scene description may be aggregated, at least in part, using the following equation:

$${\int }_{Ω} fr * Li * < wi , ns > dwi ,$$

where “fr” is the bidirectional reflectance distribution function and “Li” is the illumination model. The illumination model includes “wi,” which is the direction for incoming light, “ns” is a normal to the scene being imaged (e.g., normal to the image plane).

Advantageously, not all of the parameters for the above equation need to be solved. Indeed, the terrain model of the geographic area in combination with the previously determined location of one or more artificial lights and one or more training images (e.g., the first class of the geographic area images 202) of the geographic area at night can be used to estimate parameters for the illumination model. For example, “fr” can be approximated using the material color from a corresponding daytime aerial or non-aerial images included in the geographic area images 202. In another example, the terrain model (e.g., a digital surface model) of the geographic area can be used to generate ns (e.g., by computing a cross production of 3D vectors from two different points obtained from the terrain model). In some embodiments, only parameters for the illumination model Li associated with irradiance of the artificial light sources needs to be determined. In other embodiments, parameters for the illumination model Li associated with both location and irradiance of the artificial light sources may be determined. Specifically, using a training set of images (e.g., the first class of the geographic area images 202 showing the geographic area illuminated by one or more of the artificial light sources) with known camera parameters, multilayer perceptron parameters may be learned to iteratively generate an estimate for the irradiance parameter for each of the one or more artificial light sources (see, e.g., FIG. 3B).

Areas with sufficient lighting 232 within the geographic area may then be determined by process 207. Specifically, one or more 2D or 3D simulated aerial images representative of the geographic area at night under illumination by the artificial light sources may be rendered to represent a corresponding view of an onboard camera of a UAV at various coordinates within the geographic area in terms of both lateral and vertical positions (e.g., along at various above ground level along possible flight paths of the UAV). Pixel intensity values for regions of the one or more 2D or 3D simulated aerial images may then be compared to one or more threshold values to determine whether a given area of the geographic area associated with the compared pixel values of the one or more 2D or 3D simulated aerial images are within a threshold range (e.g., above a lower threshold and/or below an upper threshold). If the pixel intensity values are within the threshold range, then the given area may be determined to be sufficiently illuminated for UAV operation during low light conditions (e.g., a delivery zone at night may be considered viable).

FIG. 2B illustrates example simulated images rendered for UAV mission planning for light low light operation, in accordance with an embodiment of the disclosure. The example simulated images are rendered using a renderer that receives a terrain model (e.g., typically a digital surface model, but could also be a point cloud, meshes, or other three-dimensional representation) as an input or the terrain model is otherwise used to generate scene parameters, at least in part, for the renderer (see, e.g., FIG. 3B). For example, a digital surface model corresponding to or included in the terrain model could generate a height or depth map included in the scene parameters (e.g., by computing a cross product between two vectors obtained from the terrain model to determine a normal to each surface for each point within a given image plane).

The example simulated images of FIG. 2B are representative of a geographic area under different conditions and includes a day render 260, a night render without artificial light sources 270, and a night render with artificial light sources 280. More specifically, day render 260 is a 2D simulated image representative of a geographic area illuminated by sunlight. Render 270 is a 2D simulated image representative of the geographic area at night without any artificial light sources. Render 280 is a 2D simulated image representative of the geographic area at night under illumination by one or more artificial light sources (e.g., three artificial light sources as illustrated), which can be used to replicate an expected view of a UAV during a delivery mission and thus can be used as discussion in various embodiments of the disclosure (e.g., related to mission planning and/or UAV operation).

FIG. 3A illustrates an example process 300 for determining a location of one or more artificial light sources within a geographic area, in accordance with an embodiment of the disclosure. In some embodiments, process 300 may provide a location (e.g., in terms of coordinates of a spatial coordinate system or other system that may be cross-referenced to a UAV position) of one or more artificial light sources within a geographic area. In the same or other embodiments, the location provided by process 300 corresponds to an initial estimate that may later be refined (e.g., by process 350 illustrated in FIG. 3B). It is appreciated example process 300 may be one possible implementation of process 203 illustrated in FIG. 2A. As illustrated process 300 includes acquiring a geographic area image 302 (e.g., corresponding to one or more of geographic area images 202 illustrated in FIG. 2A) that includes one or more artificial light sources within a geographic area. Geographic area image 302 is subsequently input into a semantic segmentation module 310 (e.g., a convolution neural network or other deep neural network) configured to segment and annotate the input image and output annotated image 312 in response. It is appreciated that segmentation module 310 may be included in a given UAV (e.g., for real time segmentation) and/or in a backend management system in communication with the given UAV. More specifically, semantic segmentation module 310 applying semantic segmentation to geographic area image 302 (e.g., a target aerial image) to determine pixel regions of the target aerial image corresponding to one or more artificial light sources (e.g., streetlamps, light poles, porch lights, light fixtures, or other fixed artificial light sources) and identify the one or more artificial light sources within geographic area image 302 by producing annotated image 312 that corresponds to geographic area image 302 annotated to include annotations identifying which pixels included in geographic area image 302 correspond to one or more artificial light sources.

Annotated image 312 is then processed by georeference module 320 to map the annotated pixels of annotated image 312 to coordinates of a spatial coordinate system or other system that may be cross-referenced to a UAV position. Specifically, the pixel regions of geographic area image 302 annotated in annotated image 312 are georeferenced to a terrain model (e.g., a digital surface model) of the geographic area to determine where is the location of the one or more artificial light sources within the terrain model. It is appreciated that georeference module 320 may be included in a given UAV (e.g., for real time georeferencing) and/or in a backend management system in communication with the given UAV. Once the location, or approximation thereof, for the one or more artificial light sources is known, a geostore layer 322 may be generated that can be coupled to a terrain model (e.g., a digital terrain model), which that the location of the one or more artificial light sources within the terrain model is known or approximated.

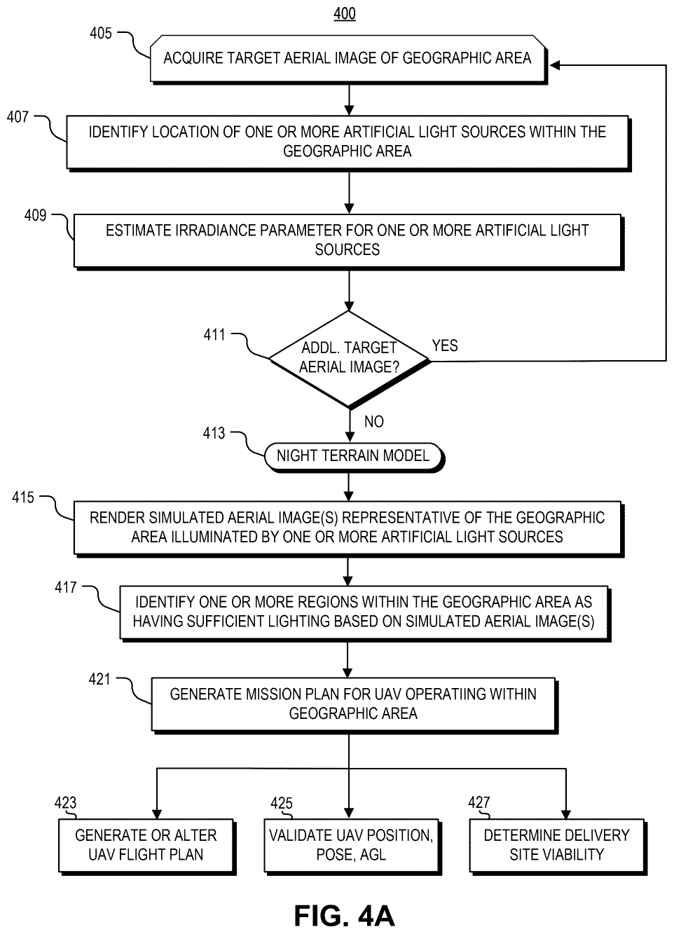

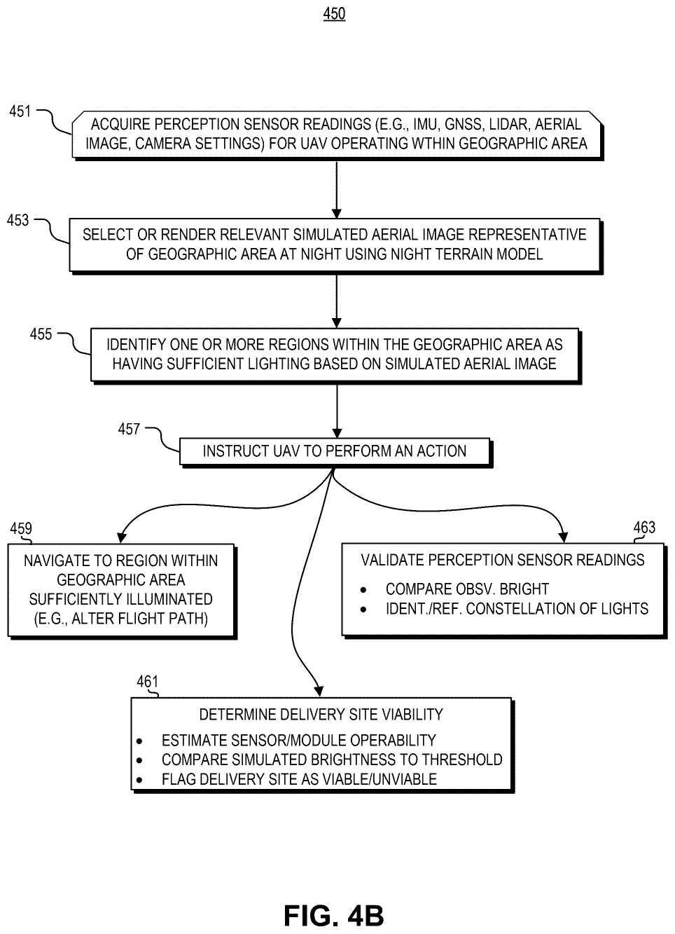

FIG. 3B illustrates an example process 350 for extracting scene parameters from an aerial image 352 and rendering a simulated aerial image 374, in accordance with an embodiment of the disclosure. Specifically, in order to determine which areas of a geographic area are sufficiently illuminated by one or more artificial light sources at night, embodiments of the disclosure further determine at least one of a location and/or illumination parameters of the one or more artificial light sources. Once the location and illumination parameters of the one or more artificial light sources within a geographic area are known, a renderer may be used to generate or render one or more simulated images (e.g., simulated aerial image 374) representative of the geographic area illuminated by one or more artificial lights at night (e.g., low light environment corresponding to the period of time between sunset and sunrise). The rendering of the one or more simulated images takes into account scene geometry (e.g., provided by a digital surface model or other terrain model) and how light from the one or more artificial light sources interacts with the scene geometry (e.g., shadowing, light occlusion, obstruction, or the like) and thus can be used to simulate what a UAV is expected to see when traversing over a geographic area and subsequently determine, for example, UAV instructions and/or mission plans (see, e.g., FIG. 4).

Example process 350 shows a multilayer perceptron 354 (e.g., a deep neural network) trained to receive aerial image 352 representative of a geographic area illuminated by one or more artificial light sources and output parameters included in scene parameters 356. The parameters output by multilayer perceptron 354 may include at least one of a location of one or more artificial light sources or an estimate for an irradiance parameter (e.g., Li included in rendering equation 365). Scene parameters 356 may further include location 360 (e.g., a geostore layer including a location of one or more artificial light sources within the geographic area), other parameters included in rendering equation 365 such as surface normals, ns, that may be extracted from digital surface model 358 (or other terrain model) of the geographic area, bidirectional reflectance distribution function, fr, that may be estimated from images of the geographic area (e.g., from geographic area images 302 illustrated in FIG. 3A), wi is the direction of incoming light, and <wi, ns> can be determined based on scene geometry (e.g., using DSM 358 and location 360).

Renderer 372 uses scene parameters 356 to generate simulated aerial image 374, which is representative of the geographic area illuminated by one or more artificial light sources (see, e.g., FIG. 2 showing example night render with artificial light sources 280). It is appreciated in some embodiments, renderer 372 may be a differential renderer (e.g., a renderer that uses a rendering equation such as rendering equation 365 to generate simulated aerial image 374). Specifically, renderer 372 may utilize scene parameters 356 with forward rendering equation 365 to produce a simulated three-dimensional environment representative of the geographic area illuminated by one or more artificial light sources. For example, forward rendering equation 365 may be used to aggregate scene information (e.g., color, density) along a ray to compute an intensity of a pixel included in an image plane (e.g., of simulated aerial image 374), which may correspond to computing the integral of forward rendering equation 365 with parameters included in forward rendering equation 365 input from scene parameters 356. The process of computing a pixel intensity may be repeated for each pixel included in the image plane to generate simulated aerial image 374, which is a simulated image representative of the geographic area illuminated by one or more artificial light sources. In such a manner, renderer 372 may use rendering equation 365 to model the brightness of a geographic area at night that is illuminated by one or more artificial light sources while taking into consideration local geometry and occlusion within the environment (e.g., objects obstructing illumination provided by the one or more artificial light sources are taken into consideration).

To facilitate rendering images of a geographic area at night that are illuminated by one or more artificial light sources, location and illumination parameters of the one or more artificial light sources are estimated or otherwise determined. As discussed previously, the location of the one or more artificial light sources, or at least an estimate thereof, may be determined by process 300 illustrated in FIG. 3A. Process 350 illustrated in FIG. 3B shows how multilayer perceptron 354 is trained to further extract illumination parameters and/or location from a given aerial image. More generally, inverse rendering may be used to estimate an irradiance parameter and/or location of one or more artificial light sources of a geographic area by using an image (e.g., aerial image 352) to recover scene information (e.g., scene parameters 356).

Specifically, when training multilayer perceptron 354, aerial image 352, which may be referred to as a training image or an interim aerial image, is input into multilayer perceptron 354 which outputs an estimate for an irradiance parameter for one or more artificial light sources included in aerial image 352 and, in some embodiments, an updated location of the one or more artificial light sources included in aerial image 352. Scene parameters 356 (e.g., obtained from multilayer perceptron 354, DSM 358, and optionally location 360) are used by renderer 372 (e.g., via rendering equation 365) to generate simulated aerial image 374. In some embodiments, renderer 372 is a differential renderer configured to receive digital surface model 358, the interim estimate of the irradiance parameter (e.g., output by multilayer perceptron 354), and the location of the one or more artificial light sources (e.g., location 360 and/or location output by multilayer perceptron 354) as an input and renderer 372 outputs the interim simulated aerial image (e.g., simulated aerial image 374) in response to receiving the aerial image. When aerial image 352 corresponds to training data (e.g., ground truth data), aerial image 352 is compared to simulated aerial image 374 using loss function 376. Loss function 375 is one example loss function that compares a rendered pixel color of simulated aerial image 374 (e.g., C_{rendered} of loss function 375) to a corresponding pixel of aerial image 352 (e.g., C of loss function 375) to determine a loss value. The loss value can then be backpropagated (e.g., using standard machine learning techniques such as gradient descent since renderer 372 and multilayer perceptron 354 are both differentiable) to determine how to update weights of multilayer perceptron 354 using the gradients to reduce the loss value obtained from the loss function 376. In such a way, weights of multilayer perceptron 354 may be iteratively updated to more accurately determine estimates for irradiance and/or location of one or more artificial light sources included in the geographic area.

Put in another way, a target aerial image (e.g., aerial image 352 that corresponds to an aerial image of a geographic area at night illuminated by one or more artificial light sources) is input into multiplayer perceptron 354 that outputs an interim estimate of an irradiance parameter (e.g., included in scene parameters 356) for the one or more artificial light sources in response. Renderer 372 is then used to render an interim simulated aerial image (e.g., simulated aerial image 374) representative of the target aerial image (e.g., aerial image 352) using DSM 358, location 360 of the one or more artificial light sources, and the interim estimate of the irradiance parameter (e.g., output by multilayer perceptron 354) for the one or more artificial light sources. Subsequently, a loss value is calculated (e.g., using loss function 376) based on a comparison between the target aerial image (e.g., aerial image 352) and the interim simulated aerial image (e.g., simulated aerial image 374). Optimization or machine learning techniques such as gradient descent may then be used to update parameters of multilayer perceptron 354 to reduce the loss value and configure multilayer perceptron 354 to subsequently revise the interim estimate of the irradiance parameter for the one or more artificial light sources included in the geographic area. This process illustrated by process 350 may be repeated such that the interim estimate of the irradiance parameter is iteratively revised by sequentially repeating the inputting the target aerial image into multilayer perceptron 354, rendering the interim simulated aerial image, calculating the loss value, and updating the parameters of the multilayer perceptron until the loss value is within a threshold range or value such that the interim estimate is sufficiently accurate and representative of the irradiance parameter for the one or more artificial light sources. It is appreciated that training of the multilayer perceptron may utilize one or more images of the geographic area at night to provide additional sources for self-supervised learning. In other words, aerial image 352 may represent a single image or multiple images that may cover the same or overlapping area (e.g., the geographic area) and be representative of the same or different views (e.g., based on angle, height, etc.) of the geographic area.

In such a manner, process 350 may be repeated for multiple images of a given geographic area to determine irradiance parameters and, optionally, locations for each artificial light source included in a given geographic area such that renderer 372 may be utilized to generate simulated aerial images representative of the geographic area illuminated at any point. In other words, digital surface model 358 representative of a geographic area, location 360 representative of locations of one or more artificial light sources within the geographic area, and irradiance parameter for each of the one or more artificial light sources may be utilized to build a night terrain model such that any representative aerial view of the geographic area illuminated by the one or more artificial light sources may be generated or otherwise rendered using renderer 372. Put in another way, process 350 may be utilized to generate a database of preprocessed images corresponding to simulated aerial images of the geographic area at night under illumination by one or more artificial light sources that is representative of what a UAV would expect to see when flying over various points in the geographic area. In such a manner, the simulated aerial images may be utilized to determine which regions or portions of the geographic area are sufficiently illuminated in a low light environment (e.g., night, dawn, dusk) for offline UAV mission planning and/or real-time UAV instructions. Collectively, multilayer perceptron 354, digital surface model 358, location 360, renderer 372, and/or any simulated aerial images generated by renderer 372 may collectively be referred to as a night terrain model of the geographic area. It is appreciated that the night terrain model may subsequently be used to determine which areas of a geographic area are sufficiently illuminated, mission planning, UAV instructions, UAV operation validation, and the like (see, e.g., process 400 illustrated in FIG. 4A and process 450 illustrated in FIG. 4B).

FIG. 4A and FIG. 4B are example flow charts illustrating process 400 and 450 for generation of a night terrain model and application of the night terrain model for UAV mission planning and operation, in accordance with embodiments of the disclosure. The order in which some or all of the process blocks appear in process 400 and 450 should not be deemed limiting. Rather, one of ordinary skill in the art having the benefit of the present disclosure will understand that some of the process blocks may be executed in a variety of orders not illustrated, or even in parallel. Further, it is appreciated that the process blocks illustrated in process 400 and 450 may be executed by a backend management system (e.g., a remote system in communication with a UAV), one or more UAVs, or a combination thereof.

FIG. 4A illustrates an example method 400 for generating a night terrain model of a geographic area and further generating a mission plan for a UAV operating within the geographic area, in accordance with an embodiment of the disclosure.

Block 405 illustrates acquiring a target aerial image of a geographic area representative of the geographic area illuminated by one or more artificial light sources. The target aerial image may correspond to an image of the geographic area captured during low light conditions (e.g., night, dawn, dusk) such that the geographic area is illuminated by one or more artificial light sources (e.g., streetlamps, porch lights, light fixtures, or other fixed artificial light sources). In some embodiments, the target aerial image corresponds to an overhead view of a geographic area captured at night by a UAV (e.g., by an onboard camera included in the UAV), a manned aerial vehicle (e.g., a helicopter or manned airplane), or a satellite.

Block 407 shows identifying a location of the one or more artificial light sources within the geographic area based, at least in part, on the target aerial image. It is appreciated that the location of the one or more artificial light sources may be determined by identifying the one or more artificial light sources included in the target aerial image by performing semantic segmentation (e.g., via a semantic segmentation module included in the UAV or the backend management system) on the target aerial image and subsequently georeferencing (e.g., via a georeferenced module included in the UAV or the backend management system) the identified one or more artificial light sources to determine the location of the one or more artificial light sources (see, e.g., process 300 illustrated in FIG. 3A). In the same or other embodiments, inverse rendering may be used to determine a location of the one or more artificial light sources (see, e.g., process 350 illustrated in FIG. 3B). In some embodiments, the location of the one or more artificial light sources corresponds to coordinates within a spatial reference system (e.g., latitude, longitude, height) and/or a location within a terrain model (e.g., a digital surface model).

Block 409 illustrates estimating an irradiance parameter for the one or more artificial light sources based, at least in part, on the target aerial image of the geographic area illuminated by the one or more artificial light sources within the geographic area. In some embodiments, the estimate for the irradiance parameter may be determined using a multilayer perceptron that is trained to output scene parameters (e.g., the estimate for the irradiance parameter) in response to receiving the target aerial image (see, e.g., process 350 illustrated in FIG. 3b). In some embodiments, the estimate for the irradiance parameter of the one or more artificial light sources may be validated comparing a simulated aerial image generated with the scene parameters (e.g., using a renderer such as renderer 372 illustrated in FIG. 3B) to the target aerial image. In other words, the irradiance parameter may be validated if the renderer can be used to reconstruct the target aerial image (e.g., the simulated aerial image is comparable within some threshold value or range to the target aerial image). It is appreciated that the one or more artificial light sources may include emitters of light within the visible spectrum of electromagnetic radiation (e.g., wavelengths from approximately 380 nm to 700 nm). In the same or other embodiments, emitters of other spectrums of electromagnetic radiation may be included (e.g., infrared) may be included in the one or more artificial light sources.

Block 411 shows a decision block. If there are additional target aerial images of the geographic location to analyze, the process 400 proceeds to block 405 and a new target aerial image is analyzed. Process blocks 405-409 may be repeated until a plurality of target aerial images have been analyzed and location and irradiance parameter estimate for the one or more artificial light sources is determined such that all artificial light sources within a given geographic area have been characterized (e.g., location and irradiance parameter for each artificial light source included in the given graphic area). In such a manner, a database describing the geographic area may be generated such that a night terrain model of the geographic area is generated.

Block 413 illustrates a night terrain model describing a geographic area based, for example, on repeated iterations of blocks 405-409. The night terrain model may include the location and the estimate for the irradiance parameter for each artificial light source included in a geographic area. It is appreciated that the term geographic area may vary broadly in scale and may cover, for example, an individual delivery site or more generally a plurality of delivery sites. The geographic area may further include an entire area a UAV is operating within, including, not but limited to from a terminal area for staging the UAV to a travel range of the UAV (e.g., to cover an area from 2 km to 160 km or more). The night terrain model may include a terrain model (e.g., digital surface model) of the geographic area, the location of each artificial light included in the geographic area, and an estimate for the irradiance parameter of each artificial light included in the geographic area.

Block 415 shows rendering (e.g., via renderer 372 illustrated in FIG. 3B) one or more simulated aerial images representative of the geographic area illuminated by one or more artificial light sources included in the geographic area using the night terrain model. In some embodiments, the simulated aerial image may be rendered using a terrain model (e.g., a digital surface model of the geographic area), the location of the one or more artificial light sources within the geographic area, and an irradiance parameter for the one or more artificial light sources within the geographic area. In some embodiments, the one or more simulated area images may be representative of a view a given UAV may be expected to observe (e.g., via one or more onboard cameras) at various points along an expected flight path when operating at night within the geographic area and while the geographic area is illuminated by the one or more artificial light sources. In some embodiments, the rendered simulated aerial images may be included in the night terrain model (e.g., to form preprocessed images representative of the geographic area at night that a given UAV access readily or otherwise store onboard the UAV for subsequent retrieval).

Block 417 illustrates identifying one or more regions within the geographic area as having sufficient lighting based on the simulated aerial images. In some embodiments, an intensity value for each pixel included in the simulated aerial image corresponds to a brightness of the pixel and may be representative of illumination brightness of a corresponding region in the geographic area. Thus, in some embodiments, the intensity value for each pixel included in the simulated aerial image may be compared to one or more threshold values or one or more threshold ranges to determine whether the pixel is sufficiently bright. For each pixel that is determined to be sufficiently bright, a location (e.g., spatial coordinates, location within the terrain model, or the like) is flagged or otherwise annotated as being sufficiently illuminated by one or more artificial light sources. Collectively, the locations flagged as being sufficiently illuminated may be referred to as one or more regions within the geographic area as having sufficient lighting (i.e., artificial light illumination at night). In some embodiments, the one or more threshold values or ranges indicative of a region being sufficiently bright may be determined with one or more UAV test flights at night in which images captured by the UAV at night, or more specifically pixel brightness or intensity, can be indexed to a visual-inertial odometry signal and/or depth reading output by the UAV when capturing a given aerial image at night. In such a way, specific brightness or intensity values for pixels included in aerial images captured by the UAV at night that are associated with a successful and/or accurate visual-inertial odometry signal and/or depth reading may be determined to define the threshold value or ranges.

Block 421 shows generating a mission plan for a UAV based on the one or more regions within the geographic area identified as having sufficient artificial light illumination. In some embodiments, the mission plan corresponds to an instruction set (e.g., stored within memory or other non-transitory storage medium included in the UAV that when executed by a control system of the UAV causes the UAV to perform operations) for a UAV to perform when delivering a parcel to a delivery site within the geographic area.

Block 423 illustrates generating or altering a UAV flight plan for the UAV, which may be included in the mission plan generated in block 421. In some embodiments, generating the mission plan for the UAV includes generating or altering a flight path included in the mission plan for the UAV to take when delivering a payload such that the one or more regions within the geographic area identified as having sufficient artificial light are within a field of view of an onboard camera of the UAV when the UAV traverses the flight path. For example, the UAV may be configured to be within a threshold lateral (e.g., x-y plane) and vertical (e.g., z-direction corresponding to altitude or above ground level) from a given artificial light source included in the one or more artificial light sources at a particular point within the flight path. In the same or other embodiments, generating or altering a UAV flight plan includes instructing the UAV to move from a first location to a second location to be closer to a specific artificial light source included in the one or more artificial light sources. In some embodiments, generating or altering the UAV flight plan may include instructing the UAV to travel from point A (e.g., a terminal area) to a delivery site (e.g., delivery site 115-A) along a path that prioritizes having one or more artificial light sources within a field of view of the UAV.

Block 425 shows including within the mission plan instructions for the UAV to validate a position (e.g., coordinates such as latitude and/or longitude) pose (e.g., orientation such as yaw, pitch, roll), or above ground level (AGL) or altitude at a specific position along the flight path, after a predetermined amount of time, or other conditional. For example, UAV position may be determined by instructing the UAV to capture an aerial image representative of the geographic area illuminated by one or more artificial light sources and finding a comparable simulated aerial image included in or rendered by the night terrain model to estimate UAV position (e.g., if the UAV observed a specific artificial light source, the same artificial light source may be found within the simulated aerial images to estimate UAV position). In another example, the mission plan may include instructions to the UAV to compare brightness of individual or groups of pixels in a target aerial image to a brightness of individual or groups of pixels included in a corresponding simulated aerial image to estimate an AGL of the UAV. Additionally, georeferencing a target aerial image to simulated aerial images generated or rendered by the night terrain model may be used to determine or otherwise validate a location or pose of the UAV. It is further appreciated that the instructions included in the mission plan may further specify validating or comparing perception sensor readings of the UAV (e.g., location based on GNSS data, pose based on IMU data, AGL based on altimeter, and the like) to the UAV position, pose, and/or AGL determined using the simulated aerial images.

Block 427 illustrates that generating the mission plan for the UAV includes determining a delivery site viability. In one embodiment, generating the mission plan for the UAV includes determining whether a delivery site within the geographic area is sufficiently illuminated by the one or more artificial lights based on the simulated aerial image. If the delivery site is considered to be sufficiently illuminated, then the mission plan for the UAV may be flagged as viable for low-light operation (e.g., at night). In some embodiments, determining whether the delivery site is sufficiently illuminated under low-light conditions includes comparing an intensity of one or more pixels of the simulated aerial image associated with the delivery site to a threshold intensity to determine whether a perception sensor (e.g., an onboard image sensor of the UAV) or module (e.g., an obstacle avoidance/abort module, a scene detection module, or a visual inertial odometry module) for the UAV is operable when the UAV is within a predetermined distance from the delivery site. More specifically, it is appreciated that operating conditions of the perception sensors or modules of the UAV may have different requirements (e.g., amount of light or illumination of a geographic area necessary for operation) to be considered operable.

For example, the obstacle avoidance/abort module (e.g., instructions for the UAV to identify a presence of an object and instruct the UAV to avoid the object or abort an action such as a descent step), the scene detection module (e.g., instructions for the UAV to identify what the object is in a scene), or a visual inertial odometry module (e.g., instructions for the UAV to determine a location, position, above ground level, or altitude) included in the perception system of the UAV use captured aerial images (e.g., the target aerial image) for various functions, which may require different levels of illumination to work in low-light conditions (e.g., at night). In some embodiments, one or more of the perception modules may be desired to be operable to at a location of a delivery site to consider the delivery site viable for low-light operation. Thus, in some embodiments, corresponding threshold values or ranges for the perception sensors or modules of the UAV may be compared to pixels representative of the delivery site included in the simulated aerial image to determine whether the delivery site is viable during low-light conditions.

FIG. 4B illustrates an example method 450 for using a night terrain model of a geographic area to instruct a UAV to perform an action, in accordance with an embodiment of the disclosure. The night terrain model may correspond to the night terrain model generated in process 450 of FIG. 4A. The night terrain model may further include preprocessed or pre-rendered simulated aerial images of the geographic area illuminated by one or more artificial light sources (e.g., to facilitate real-time decision making by the UAV).

Block 451 illustrates acquiring perception sensor readings (e.g., IMU, GNSS, LIDAR, aerial image, camera settings or intrinsics such as focal length, zoom, resolution, etc., other sensor readings, or combinations thereof) for a UAV operating within a geographic area illuminated by one or more artificial light sources in low-light conditions (e.g., night). In some embodiments, acquiring perception sensor readings of the UAV includes capturing a target aerial image representative of the geographic area below the UAV with an onboard camera of the UAV. In some embodiments, the perception sensor readings (GNSS readings, IMU readings, altimeter readings, stereovision depth readings, etc.) may be indexed to the target aerial image. In some embodiments, the target aerial image may be included in an aerial view or otherwise aerial images may be acquired at a regular video frame rate (e.g., 20 f/s, 30 f/s, etc.) and a subset of the images denoted as a target aerial image to be provided to the various modules of the UAV for UAV operation (e.g., navigation, validation of perception sensor readings, delivery site viability, and the like). In some embodiments, an IMU of the UAV includes one or more of an accelerometer, a gyroscope, or a magnetometer to capture accelerations (linear or rotational), attitude, and heading readings. In the same or other embodiments, a GNSS sensor of the UAV may be a global positioning system (GPS) sensor, or otherwise, and output longitude/latitude position, mean sea level (MSL) altitude, heading, etc.

Block 453 shows selecting (e.g., from preprocessed or rendered simulated aerial images of the geographic area) or rendering (e.g., using a renderer such as renderer 372 illustrated in FIG. 3B) a simulated aerial image representative of the geographic area illuminated by the one or more artificial light sources using a night terrain model (e.g., the night terrain model generated in process 400 illustrated in FIG. 4A). In some embodiments, perception sensor readings are utilized to select or renderer the simulated aerial image (e.g., IMU and GNSS readings may be utilized to reproduce or select a pre-rendered simulated aerial image that is expected to be what the UAV will see at a current position or an expected position along a flight path of the UAV). In one embodiment, the simulated aerial image illuminated by the one or more artificial light sources is rendered using coordinates of the UAV based on the perception sensor readings, a digital surface model of the geographic area, a location of the one or more artificial light sources, and an irradiance parameter for the one or more artificial light sources. In some embodiments, the simulated aerial image is representative of the target aerial image (e.g., obtained when acquiring perception sensor readings). However, in other embodiments, the simulated aerial image is representative of what the UAV is expected to observe at a position different from a current UAV position (e.g., a different altitude, latitude, longitude, or combinations thereof). For example, in one embodiment the target aerial image may be representative of a view from an onboard camera of a UAV at a first altitude or AGL above a delivery site and the simulated aerial image is representative of a view from an onboard camera of the UAV at a second altitude or AGL lower than the first altitude or AGL (e.g., such that the lower simulated view can be used to determine whether the delivery site is sufficiently illuminated at night or the delivery should be aborted). In other words, in some embodiments, the target aerial image is representative of a first field of view for the UAV at a first AGL and the simulated aerial image is representative of a second field of view for the UAV at a second AGL less than the first AGL.

Block 455 illustrates identifying one or more regions within the geographic area as having sufficient lighting from the one or more artificial light sources based, at least in part, on the simulated aerial image. As discussed previously in relation to block 417 of process 400, sufficient lighting may be determined by comparing an intensity value for one or more pixels included in the simulated aerial image to one or more threshold values or ranges. For each pixel that is determined to be sufficiently bright, a location (e.g., spatial coordinates, location within the terrain model, or the like) is flagged or otherwise annotated as being sufficiently illuminated by one or more artificial light sources. Collectively, the locations flagged as being sufficiently illuminated may be referred to as one or more regions within the geographic area as having sufficient lighting (i.e., artificial light illumination at night).

Block 457 shows instructing the UAV to perform an action based, at least in part, on the one or more regions within the geographic area identified as having sufficient artificial light illumination.

Block 459 illustrates an example of an action for the UAV to perform and includes navigating to a region within the geographic area identified as sufficiently illuminated. For example, a flight path of the UAV may be altered and the UAV instructed to navigate such that one or more artificial light sources providing illumination at night are within a threshold distance (e.g., lateral and/or vertical) from the UAV. In some embodiments, the action includes altering a flight path of the UAV to take when delivering a payload or parcel such that at least one of the one or more regions within the geographic area identified as having sufficient artificial light illumination is within a field of view of an onboard camera of the UAV when the UAV traverses the flight path.

Block 461 shows an example of an action for the UAV to perform and includes determining delivery site viability. In one embodiment, the action includes validating whether a delivery site included in the geographic area is viable for low-light operation based, at least in part, on the simulated aerial image. In some embodiments, the simulated aerial image(s) corresponds to an expected view of the delivery site from an onboard camera of the UAV at a height or a location of the UAV different from a current height or current location of the UAV. More specifically, the simulated aerial image can be selected or rendered at any height (e.g., AGL) or location (e.g., latitude and longitude) of the UAV within the geographic area to understand what a given area (e.g., delivery site) is expected to look like so the UAV can “understand” what viewed is expected to be observed before the UAV is physically at the given area. This enables the UAV to evaluate the given area before flying to or otherwise being at the given area. For example, the UAV at the first AGL may renderer or select a simulated aerial image representative of the UAV at the second AGL to estimate whether an underlying delivery site is sufficiently illuminated (e.g., by comparing pixel intensity of the simulated aerial image to a threshold value or range).

In the same or other embodiments, validating whether the delivery site is sufficiently illuminated includes comparing an intensity of one or more pixels of the simulated aerial image associated with the delivery site to a threshold intensity to determine whether a perception sensor (e.g., the onboard camera of the UAV) or module (e.g., an obstacle avoidance/abort module, a scene detection module, or a visual inertial odometry module included in the UAV) is operable when the UAV is within a predetermined distance from the delivery site. In some embodiments, a delivery site will be flagged as viable or unviable depending on the outcome of the comparison between the simulated aerial image and the threshold value or ranges. In some embodiments, if the delivery site is deemed unviable a new delivery site may be selected or the mission aborted.

Block 463 illustrates an example of an action for the UAV to perform and includes validating one or more perception sensor readings of the UAV using the night terrain model. In some embodiments, the action includes estimating at least one of an above ground level (AGL), a position, or an orientation of the UAV based, at least in part, on the simulated aerial image or other readings included in the perception sensor reads. In the same or another embodiment, the action further includes comparing the at least one of the AGL, the position, or the orientation of the UAV to a corresponding estimate of the AGL, the position, or the orientation of the UAV associated with the perception sensor readings of the UAV to validate at least one of the perception sensor readings. In the same or other embodiments, estimating the AGL of the UAV includes comparing an observed brightness of the one or more artificial light sources included in the target aerial image to a simulated brightness of the one or more artificial light sources included in the simulated aerial image. In some embodiments, estimating the position and/or orientation of the UAV includes identifying a constellation of lights observed by the UAV included in the target aerial image and referencing the constellation of lights to the simulated aerial image to estimate the position and/or orientation of the UAV. In one embodiment, the target aerial image captured by the UAV may be compared to the simulated aerial image (e.g., corresponding to a baseline image of known lights at night) that can be compared to validate and/or correct GNSS data. In some embodiments, the position of the UAV corresponds to latitude and longitude of the UAV when the target aerial image was captured.

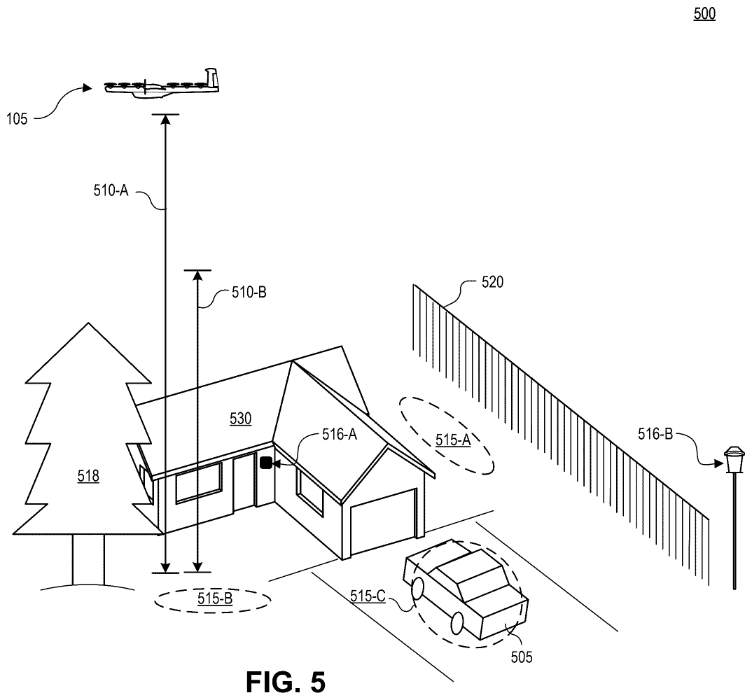

FIG. 5 illustrates a UAV 105 verifying delivery site viability included in geographic area 500 using a night terrain model, in accordance with an embodiment of the disclosure. It is appreciated that the example provided in FIG. 5 is a possible way to implement the methods 400 and 450 illustrated in FIG. 4A and FIG. 4B may be utilized. As illustrated UAV is operating within geographic area 500 at night (e.g., a low light environment) and is positioned at a first AGL 510-A to capture a target aerial image of geographic area 500 showing delivery sites 515-A, 515-B, and 515-C. In some embodiments, the target aerial image may be utilized to identify and locate artificial light sources 516-A and 516-B. In the same or other embodiments, the target aerial image may be used to validate that one or more artificial light sources expected to be within geographic area 500 are emitting light (e.g., such that the appropriate simulated aerial image may be selected or rendered).

In the illustrated embodiment, UAV 105 is configured to select or render a simulated aerial image representative of the geographic area 500 at a second AGL 510-B that is closer to delivery sites 515-A, 515-B, and 515-C to determine whether the delivery sites 515-A, 515-B, and 515-C are sufficiently illuminated by artificial light sources 516-A and 516-B. In some embodiments, the simulated aerial image is selected from a plurality of preprocessed or pre-rendered simulated aerial images of the geographic area 500. In other embodiments, the simulated aerial image is rendered. For example, the target aerial image captured at first AGL 510-A is utilized to estimate an irradiance parameter of the artificial light sources 516-A and 516-B (e.g., using multilayer perceptron 354 illustrated in FIG. 3B). In other embodiments, a location and irradiance parameter of artificial light sources 516-A and 516-B was previously determined. The irradiance parameter, location, and other scene parameters from a digital surface model of geographic area 500 may be used with a renderer (e.g., collectively corresponding to a night terrain model) to render the simulated aerial image representative of geographic area 500 at the second AGL 510-B.

The rendered simulated aerial image is representative of the geographic area 500 illuminated by artificial light sources 516-A and 516-B. Intensity values for pixels included in the simulated aerial image associated with delivery sites 515-A, 515-B, and 515-C may be compared to threshold intensity value(s) to determine whether delivery sites 515-A, 515-B, and/or 515-C are viable for payload delivery during low light (e.g., at night when UAV 105 is operating). In the illustrated embodiment, delivery sites 515-B and 515-C are determined to be sufficiently illuminated by artificial light sources 516-A and 516-B while delivery site 515-A is determined to be insufficiently illuminated (e.g., tree 518, fence 520, and/or house 530 obstruct light from artificial light sources 516-A and/or 516-B within geographic area 500 from reaching or otherwise illuminating delivery site 515-A sufficiently). UAV 105 may also use one or more perception modules (e.g., scene detection, obstacle avoidance/abort, or the like) to determine delivery site 515-C is obstructed by vehicle 505 and thus select delivery site 515-B to deliver the payload.

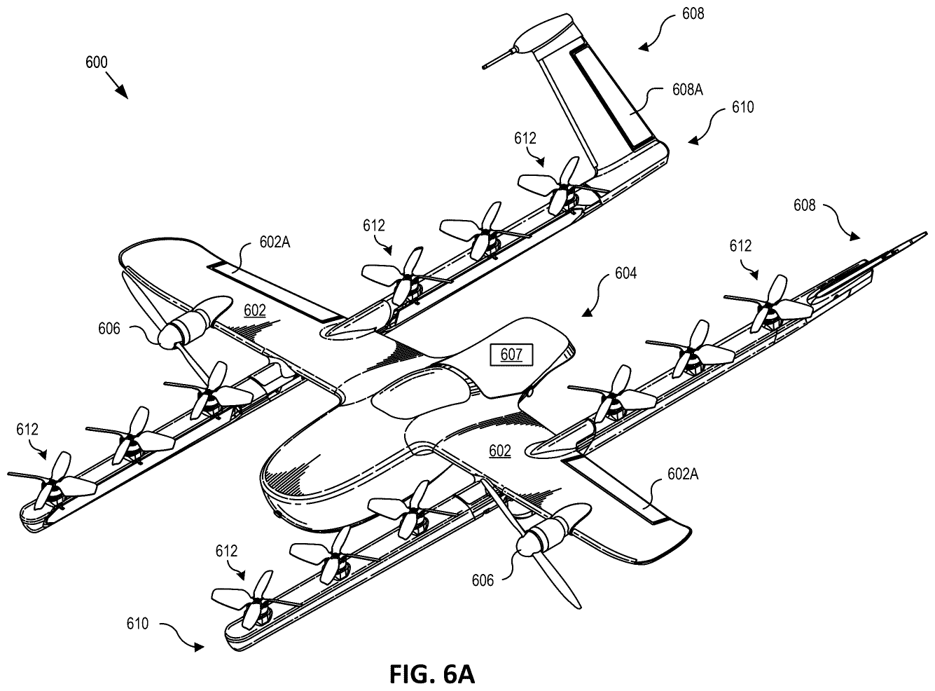

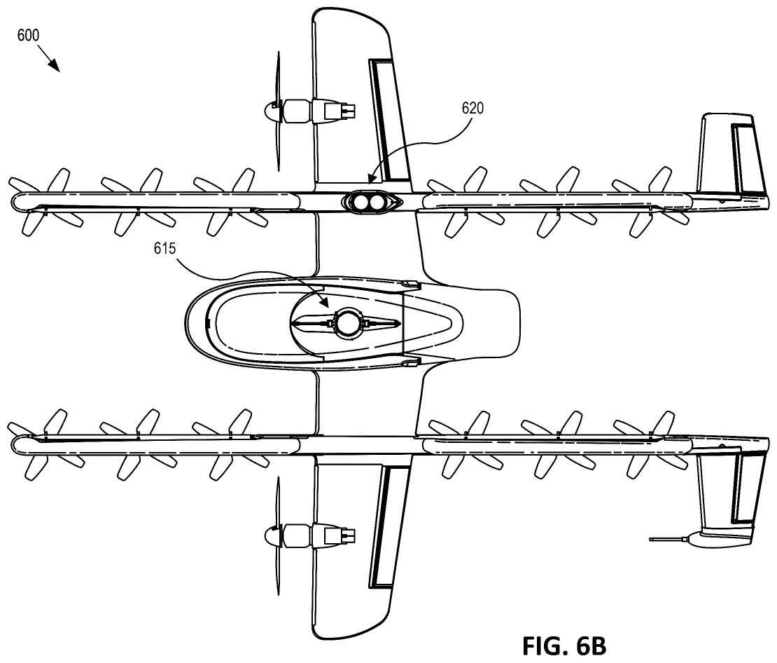

FIGS. 6A and 6B illustrate a UAV 600 that is well suited for delivery of payloads, in accordance with an embodiment of the disclosure. FIG. 6A is a topside perspective view illustration of UAV 600 while FIG. 6B is a bottom side plan view illustration of the same. UAV 600 is one possible implementation of UAVs 105 illustrated in FIG. 1, although other types of UAVs may be implemented as well.

The illustrated embodiment of UAV 600 is a vertical takeoff and landing (VTOL) UAV that includes separate propulsion units 606 and 612 for providing horizontal and vertical propulsion, respectively. UAV 600 is a fixed-wing aerial vehicle, which as the name implies, has a wing assembly 602 that can generate lift based on the wing shape and the vehicle's forward airspeed when propelled horizontally by propulsion units 606. The illustrated embodiment of UAV 600 has an airframe that includes a fuselage 604 and wing assembly 602. In one embodiment, fuselage 604 is modular and includes a battery module, an avionics module, and a mission payload module. These modules are secured together to form the fuselage or main body.

The battery module (e.g., fore portion of fuselage 604) includes a cavity for housing one or more batteries for powering UAV 600. The avionics module (e.g., aft portion of fuselage 604) houses flight control circuitry of UAV 600, which may include a processor and memory, communication electronics and antennas (e.g., cellular transceiver, wifi transceiver, etc.), and various perception sensors (e.g., global positioning sensor, an inertial measurement unit, a magnetic compass, a radio frequency identifier reader, etc.). In some embodiments, instructions stored on the memory of the UAV may include an obstacle avoidance/abort module, a scene detection module, or a visual inertial odometry module, a renderer, a multilayer perceptron, and/or any other component for facilitating UAV performing method 300 illustrated in FIG. 3A, method 350 illustrated in FIG. 3B, method 400 illustrated in FIG. 4A, and/or method 450 illustrated in FIG. 4B). Collectively, these functional electronic subsystems for controlling UAV 600, communicating, and sensing the environment may be referred to as a control system 607. Control system 607 may incorporate the functional components for accomplishing method 300 illustrated in FIG. 3A, method 350 illustrated in FIG. 3B, method 400 illustrated in FIG. 4A, and/or method 450 illustrated in FIG. 4B. The mission payload module (e.g., middle portion of fuselage 604) houses equipment associated with a mission of UAV 600. For example, the mission payload module may include a payload actuator 615 for holding and releasing an externally attached payload (e.g., package for delivery). In some embodiments, the mission payload module may include camera/sensor equipment included in perception sensors of the UAV (e.g., camera, lenses, radar, lidar, pollution monitoring sensors, weather monitoring sensors, scanners, etc.). In some embodiments, an onboard camera 620 is mounted to the underside of UAV 600 to support a computer vision system (e.g., stereoscopic machine vision) for visual triangulation and navigation as well as operate as an optical code scanner for reading visual codes affixed to packages. These visual codes may be associated with or otherwise match to delivery missions and provide the UAV with a handle for accessing destination, delivery, and package validation information. Of course, onboard camera 620 may alternatively be integrated within fuselage 604.

As illustrated, UAV 600 includes horizontal propulsion units 606 positioned on wing assembly 602 for propelling UAV 600 horizontally. UAV 600 further includes two boom assemblies 610 that secure to wing assembly 602. Vertical propulsion units 612 are mounted to boom assemblies 610. Vertical propulsion units 612 providing vertical propulsion. Vertical propulsion units 612 may be used during a hover mode where UAV 600 is descending (e.g., to a delivery location), ascending (e.g., at initial launch or following a delivery), or maintaining a constant altitude. Stabilizers 608 (or tails) may be included with UAV 600 to control pitch and stabilize the aerial vehicle's yaw (left or right turns) during cruise. In some embodiments, during cruise mode vertical propulsion units 612 are disabled or powered low and during hover mode horizontal propulsion units 606 are disabled or powered low.

During flight, UAV 600 may control the direction and/or speed of its movement by controlling its pitch, roll, yaw, and/or altitude. Thrust from horizontal propulsion units 606 is used to control air speed. For example, the stabilizers 608 may include one or more rudders 608a for controlling the aerial vehicle's yaw, and wing assembly 602 may include elevators for controlling the aerial vehicle's pitch and/or ailerons 602a for controlling the aerial vehicle's roll. While the techniques described herein are particularly well-suited for VTOLs providing an aerial delivery service, it should be appreciated that analyzing shadow lengths to infer the heights of ground-based obstacles is applicable to a variety of aircraft types (not limited to VTOLs) providing a variety of services or serving a variety of functions beyond package deliveries.

Many variations on the illustrated fixed-wing aerial vehicle are possible. For instance, aerial vehicles with more wings (e.g., an “x-wing” configuration with four wings), are also possible. Although FIGS. 6A and 6B illustrate one wing assembly 602, two boom assemblies 610, two horizontal propulsion units 606, and six vertical propulsion units 612 per boom assembly 610, it should be appreciated that other variants of UAV 600 may be implemented with more or less of these components.

It should be understood that references herein to an “unmanned” aerial vehicle or UAV can apply equally to autonomous and semi-autonomous aerial vehicles. In a fully autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator may control high level navigation decisions for a UAV, such as specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. A computer-implemented method, comprising:
acquiring a target aerial image of a geographic area representative of the geographic area illuminated by one or more artificial light sources;
identifying a location of the one or more artificial light sources within the geographic area based, at least in part, on the target aerial image;
rendering a simulated aerial image representative of the geographic area illuminated by the one or more artificial light sources at night using a digital surface model of the geographic area, the location of the one or more artificial light sources, and an irradiance parameter for the one or more artificial light sources;
identifying one or more regions within the geographic area as having sufficient lighting provided by the one or more artificial light sources for UAV operation at night based on the simulated aerial image; and
generating a mission plan for an unmanned aerial vehicle (UAV) based on the one or more regions within the geographic area identified as having sufficient artificial light illumination.

2. The computer-implemented method of claim 1, wherein generating the mission plan for the UAV includes generating or altering a flight path included in the mission plan for the UAV to take when delivering a payload such that the one or more regions within the geographic area identified as having sufficient artificial light are within a field of view of an onboard camera of the UAV when the UAV traverses the flight path.

3. The computer-implemented method of claim 1, wherein generating the mission plan for the UAV includes determining whether a delivery site within the geographic area is sufficiently illuminated by the one or more artificial lights based on the simulated aerial image; and
flagging the mission plan for the UAV as viable for low-light operation when the delivery site is determined to be sufficiently illuminated.

4. The computer-implemented method of claim 3, wherein the determining whether the delivery site within the geographic area is sufficiently illuminated includes:
comparing an intensity of one or more pixels of the simulated aerial image associated with the delivery site to a threshold intensity to determine whether a perception module for the UAV is operable when the UAV is within a predetermined distance from the delivery site.

5. The computer-implemented method of claim 4, wherein the perception module corresponds to at least one of an obstacle avoidance/abort module, a scene detection module, or a visual inertial odometry module.

6. The computer-implemented method of claim 1, wherein identifying the location of the one or more artificial light sources includes:
applying semantic segmentation to the target aerial image to determine pixel regions of the target aerial image corresponding to the one or more artificial light sources; and
georeferencing the pixel regions of the target aerial image to a digital surface model of the geographic area to determine where the location of the one or more artificial light sources is within the digital surface model.

7. The computer-implemented method of claim 1, further comprising estimating the irradiance parameter using inverse rendering based on the target aerial image.

8. The computer-implemented method of claim 7, wherein the estimating the irradiance parameter includes:
inputting the target aerial image into a multilayer perceptron that outputs an interim estimate of the irradiance parameter for the one or more artificial light sources in response;
rendering an interim simulated aerial image representative of the target aerial image using the digital surface model, the location of the one or more artificial light sources, and the interim estimate of the irradiance parameter for the one or more artificial light sources;
calculating a loss value with a loss function based on a comparison between the target aerial image and the interim simulated aerial image; and
updating parameters of the multilayer perceptron to reduce the loss value and configure the multilayer perceptron to subsequently revise the interim estimate of the irradiance parameter for the one or more artificial light sources.

9. The computer-implemented method of claim 8, further comprising:
iteratively revising the interim estimate of the irradiance parameter by sequentially repeating the inputting the target aerial image into the multilayer perceptron, the rendering the interim simulated aerial image, the calculating the loss value, and the updating the parameters of the multilayer perceptron until the loss value is within a threshold range such that the interim estimate corresponds to the irradiance parameter.

10. The computer-implemented method of claim 8, wherein the interim simulated aerial image is rendered with a differential renderer configured to receive the digital surface model, the interim estimate of the irradiance parameter, and the location of the one or more artificial light sources as an input, and wherein the differential renderer outputs the interim simulated aerial image in response to receiving the input.

11. The computer-implemented method of claim 1, wherein the one or more artificial light sources include at least one of a light pole, a streetlamp, or a light fixture.

12. A computer-implemented method for estimating an irradiance parameter of an artificial illumination source, comprising:
acquiring a target aerial image of a geographic area illuminated by an artificial light source;
inputting the target aerial image into a multilayer perceptron that outputs an interim estimate of the irradiance parameter for the artificial light source in response;
rendering an interim simulated aerial image representative of the target aerial image using the digital surface model, the location of the artificial light source, and the interim estimate of the irradiance parameter for the artificial light source;
calculating a loss value with a loss function based on a comparison between the target aerial image and the interim simulated aerial image;
updating parameters of the multilayer perceptron to reduce the loss value and configure the multilayer perceptron to subsequently revise the interim estimate of the irradiance parameter for the artificial light source;
rendering a simulated aerial image representative of the geographic area using a digital surface model of the geographic area, a location of the artificial light source, and an irradiance parameter estimate for the artificial light source;
identifying one or more regions within the geographic area as having sufficient lighting based on the simulated aerial image; and
instructing the UAV to perform an action based on the one or more regions within the geographic area identified as having sufficient artificial light illumination.

13. At least one non-transitory computer-readable medium storing instructions that, when executed by a control system of an unmanned aerial vehicle (UAV), will cause the UAV to perform operations comprising:
acquiring perception sensor readings of the UAV operating within a geographic area;
selecting or rendering a simulated aerial image representative of the geographic area illuminated by one or more artificial light sources using a night terrain model;
identifying one or more regions within the geographic area as having sufficient lighting from the one or more artificial light sources based on the simulated aerial image; and
instructing the UAV to perform an action based on the one or more regions within the geographic area identified as having sufficient artificial light illumination.

14. The at least one non-transitory computer-readable medium of claim 13, wherein the action includes altering a flight path of the UAV to take when delivering a payload such that the one or more regions within the geographic area identified as having sufficient artificial light illumination are within a field of view of an onboard camera of the UAV when the UAV traverses the flight path.

15. The at least one non-transitory computer-readable medium of claim 13, wherein the action includes validating whether a delivery site included in the geographic area is viable for low-light operation based, at least in part, on the simulated aerial image, wherein the simulated aerial image corresponds to an expected view of the delivery site from an onboard camera of the UAV at a height or a location of the UAV different from a current height or current location of the UAV.

16. The at least one non-transitory computer-readable medium of claim 15, wherein the validating whether the delivery site is sufficiently illuminated includes comparing an intensity of one or more pixels of the simulated aerial image associated with the delivery site to a threshold intensity to determine whether a perception module for the UAV is operable when the UAV is within a predetermined distance from the delivery site.

17. The at least one non-transitory computer-readable medium of claim 13, wherein the acquiring perception sensor readings of the UAV includes capturing a target aerial image representative of the geographic area below the UAV, and wherein the instructing the UAV to perform the action further includes:
estimating at least one of an above ground level (AGL), a position, or an orientation of the UAV based, at least in part, on the simulated aerial image; and
comparing the at least one of the AGL, the position, or the orientation of the UAV to a corresponding estimate of the AGL, the position, or the orientation of the UAV associated with the perception sensor readings of the UAV to validate at least one of the perception sensor readings.

18. The at least one non-transitory computer-readable medium of claim 17, wherein the estimating the AGL of the UAV includes comparing an observed brightness of the one or more artificial light sources included in the target aerial image to a simulated brightness of the one or more artificial light sources included in the simulated aerial image.

19. The at least one non-transitory computer-readable medium of claim 17, wherein the estimating the position of the UAV includes:
identifying a constellation of lights observed by the UAV included in the target aerial image; and
referencing the constellation of lights to the simulated aerial image to estimate the position of the UAV.

20. The at least one non-transitory computer-readable medium of claim 13, wherein the simulated aerial image illuminated by the one or more artificial light sources is rendered using coordinates of the UAV based on the perception sensor readings, a digital surface model of the geographic area, a location of the one or more artificial light sources, and an irradiance parameter for the one or more artificial light sources such that the simulated aerial image takes into account scene geometry provided by the digital surface model and how light from the one or more artificial light sources interacts with the scene geometry.
